(19) United States
(12) Patent Application Publication
(10) Pub. No.: US 2003/0182523 A1
(43) Pub. Date: Sep. 25, 2003

(54) Cache memory control device and cache memory system

(75) Inventor: Asao Kokubo, Kawasaki (JP)

Correspondence Address: ARENT FOX KINTNER PLOTKIN & KAHN, 1050 CONNECTICUT AVENUE, N.W., SUITE 400, WASHINGTON, DC, 20036, US

(73) Assignee: FUJITSU LIMITED

(21) Appl. No.: 10/345,986

(22) Filed: Jan. 17, 2003

(30) Foreign Application Priority Data
Mar. 19, 2002 (JP) 2002-075484

(51) Int. Cl. G06F 12/00; G06F 12/14

(52) U.S. Cl. 711/156; 711/163

(57) ABSTRACT

At the preparation stage of an application program, freezing control information is added to data which is desired to reside in a cache, and the freezing control information is taken into a cache memory control device, together with the data from a main memory, at the time of executing the application program. When adding the freezing control information to the data, a portion to be frozen in the application program, which is described in a high-level language, is enclosed by a special designator. When this portion is converted to data by a compiler or the like, data added with the freezing control information is generated based on the designator.

### CROSS-REFERENCE TO RELATED APPLICATIONS

This application is based upon and claims the benefit of priority from the prior Japanese Patent Application No.2002-075484, filed on Mar. 19, 2002, the entire contents of which are incorporated herein by reference.

### BACKGROUND OF THE INVENTION

1) Field of the Invention

The present invention relates to a cache memory control device and a cache memory system having a freezing function, in which, to realize execution of a computer program in real time, a copy of the computer program is made to reside in a cache memory.

2) Description of the Related Art

In a computer system or the like, the main memory, which is generally provided externally, has a lower access rate than the CPU. Therefore, a cache memory is generally used to increase the throughput of an access to the main memory.

As shown in FIG. 1, a cache memory control device 1 is arranged between a CPU 2 and a main memory 3. As shown in FIG. 2, the cache memory control device 1 (cache memory) has a higher access speed but has a smaller memory capacity than the main memory 3. Therefore, only a part of the data expanded in the external memory can be stored in the cache memory 1.

When new data is to be stored in the cache memory when there is no free space, the data already stored in the cache memory is overwritten by the new data. However, if data that is frequently required is overwritten by some other data, then the frequently required data is required to be read from the main memory from time to time. As a result, the throughput decreases.

A cache memory control device that has a freezing function is known. In such a cache memory control device, data that is frequently accessed is prevented from being overwritten. Thus, since the frequently accessed data can reside in the cache memory, the throughput does not decrease.

FIG. 3 is a block diagram which shows a cache memory control device of a direct map (or one way set associative) method, which has a conventional freezing function. Reference numeral 11 denotes a tag RAM, 12 denotes a valid RAM, 13 denotesa data RAM, 14 denotes a hit judgment control circuit, 15 denotes a comparator, 16 denotes a freezing controller, 17 denotes a selector (MUX), 18 denotes an adder, and 19 denotes a purge controller.

When an access request is issued from the CPU to the main memory, the hit judgment control circuit 14 judges whether to output the data requested from the CPU from the data RAM 13 (cache hit), or to make an access request to the main memory (cache miss). At the time of this judgment, the CPU refers to freezing control information frz stored in the freezing controller 16. The CPU supplies this freezing control information frz to the freezing controller 16. In other words, acceptance or rejection control of the freezing function is carried out through a register access, such as an issuance of a request signal or freezing instruction from the CPU to the cache memory control device.

At the time of cache hit judgment, a result of comparison of an address stored in the tag RAM 11 (tag data) and the tag address, and data stored in the valid RAM 12 (valid data) are referred together with the freezing control information frz. The operation of the cache memory control device, which is executed based on these reference values, is shown in FIG. 4.

However, it is necessary to insert a freezing instruction at an appropriate position in the program, in order to allow the intended data to reside in the cache in the conventional cache memory control device. When the data for a plurality of blocks scattered in the main memory is made to reside in the cache, the insertion position of the freezing instruction becomes complicated, thereby causing a problem in that the burden on the programmer increases. Further, there may be such situation that unscheduled data resides therein due to an unscheduled interrupt operation of the CPU, and hence a program (freezing setting program) for performing redundant preprocessing in order to avoid this is required, thereby causing a problem in that the whole program size increases.

The relation between the data arrangement position on the main memory and the data arrangement position on the data RAM changes according to the configuration of the CPU and the cache memory control device. Therefore, when the configuration thereof changes, the program prepared in a high-level language has to be converted into a low-level language, to thereby correct the insertion position of the freezing instruction, corresponding to the configuration of the CPU and the cache memory control device. Therefore, there is a problem in that the portability and readability of program is deteriorated. Further, debugging operation increases at the time of preparation of the program.

### SUMMARY OF THE INVENTION

It is an object of this invention to provide the cache memory control device and the cache memory system, in which desired data can be made to reside in the cache automatically and reliably, only by executing an application program, without separately providing a freezing setting program, and the application program can have a program configuration having high portability, which does not rely on the hardware configuration of the CPU, the cache memory control device or the like.

According to one aspect of the present invention, freezing control information is added to data which is desired to reside in a cache, at a preparation stage of an application program, and at the time of executing the application program, the freezing control information is taken in from the main memory together with the data. Generally, the data which is required to reside in the cache is determined at the preparation stage of the application program, and does not dynamically change due to the execution of the application program. Therefore, as described above, it is possible to add the freezing control information to the data in advance. In order to add the freezing control information to the data, such a configuration is necessary that a portion to be frozen in the application program, which is described in a high-level language, is enclosed by a special designator, and when this portion is converted to data by a compiler or the like, data added with the freezing control information is generated based on the designator.

According to the above aspect, since the freezing control information is taken in together with the data requested from a CPU from a main memory to a cache memory control device, setting of data which is made to reside in the cache is carried out automatically. Further, since command description for specifying the portion to be frozen in the application program is unnecessary, the description does not depend on the hardware configuration of the CPU, the cache memory control device or the like with respect to the application program.

According to the present invention, since the freezing control information is taken in together with the data requested from the CPU from the main memory to the cache memory control device, setting of data which is made to reside in the cache is carried out automatically. Therefore, desired data can be made to reside in the cache automatically and reliably, only by executing an application program, without separately providing a freezing setting program. Further, since command description for specifying the portion to be frozen in the application program is unnecessary, the description does not depend on the hardware configuration of the CPU, the cache memory control device or the like.

These and other objects, features and advantages of the present invention are specifically set forth in or will become apparent from the following detailed descriptions of the invention when read in conjunction with the accompanying drawings.

### BRIEF DESCRIPTION OF THE DRAWINGS

FIG. 1 is a conceptual diagram which shows the connection between the cache memory control device and a CPU and a main memory,

FIG. 2 is a diagram which shows comparison between a cache memory and an external memory,

FIG. 3 is a block diagram which shows a conventional cache memory control device,

FIG. 4 is a diagram which shows the operation of the cache memory control device,

FIG. 5 is a block diagram which shows one example of a cache memory control device according to an embodiment of the present invention,

FIG. 6 is a diagram which shows an example of a C program for instructing the range to be frozen in the embodiment of the present invention, and

FIG. 7 is a block diagram which shows another example of the cache memory control device according to the embodiment of the present invention.

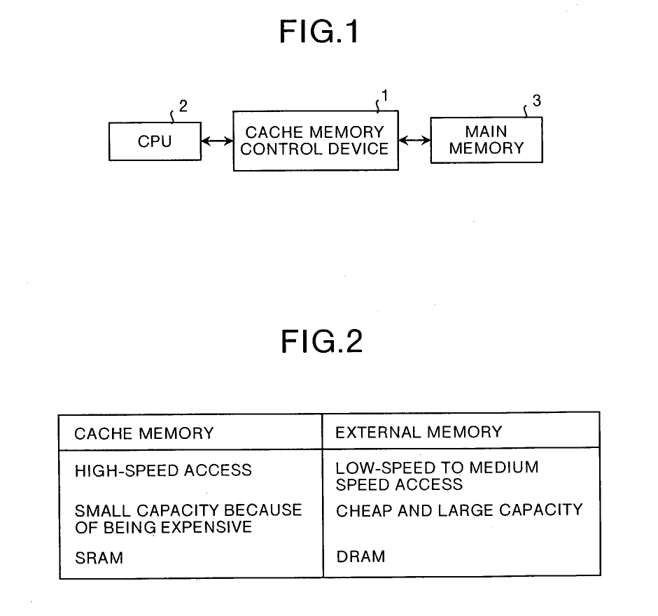

### DETAILED DESCRIPTIONS

An embodiment of the present invention will now be explained in detail, with reference to the accompanying drawings. In this embodiment, as an example, a data cache of a direct map (or one way set associative) method aiming at data other than instructions, of the request data from a CPU, will be explained.

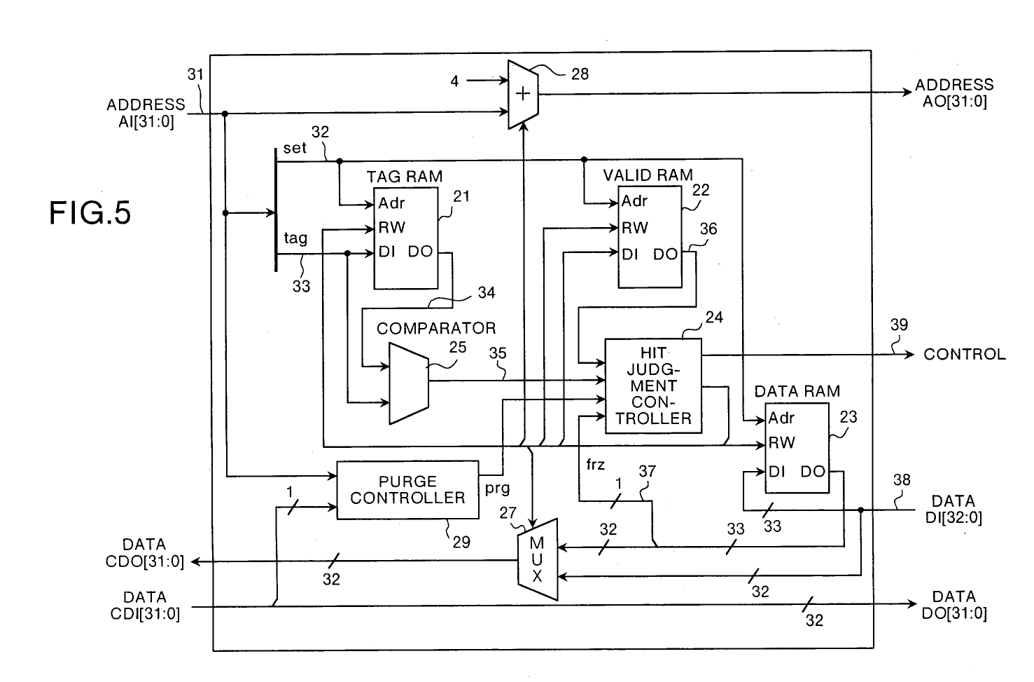

FIG. 5 is a block diagram which shows an example of a cache memory control device according to the embodiment of the present invention. As shown in FIG. 5, this cache memory control device comprises a tag RAM 21 which constitutes a tag memory, a valid RAM 22 which constitutes a valid memory, a data RAM 23 which constitutes a data memory, a hit judgment control circuit 24 which is a hit judgment controller, a comparator 25, a selector (MUX) 27, an adder 28, and a purge controller 29.

When the cache memory control device receives an access request to a main memory from the CPU, the data on an address bus 31 is broken down to a set address 32 and a tag address 33. The set address 32 is input to an address input terminal Adr in the tag RAM 21. The tag RAM 21 outputs data (tag data) 34 corresponding to the input set address 32 from a data output terminal DO. The output tag data 34 is input to one of the input terminals of the comparator 25. The tag address 33 is input to the other input terminal of the comparator 25. The comparator 25 compares the tag address 33 and the tag data 34. The comparison result 35 is supplied to the hit judgment control circuit 24.

The set address 32 is input to an address input terminal Adr of the valid RAM 22. The valid RAM 22 outputs data (valid data) 36 corresponding to the input set address 32 from the data output terminal DO. The output valid data 36 is supplied to the hit judgment control circuit 24. The set address 32 is input to an address input terminal Adr of the data RAM 23. The data RAM 23 outputs freezing control information (frz) 37 accompanying the data corresponding to the input set address 32, from the data output terminal DO. The output freezing control information 37 is supplied to the hit judgment control circuit 24.

The freezing control information 37 is information transmitted from a main memory (not shown) via a data bus 38, at the time of burst read operation, for example, one-bit information accompanying the 32-bit data. In this case, the bus width of the data bus 38 becomes 33 bits. The data RAM 23 receives these data and the freezing control information 37 at the data input terminal DI and stores them. Therefore, the data bus and a signal path denoted by reference numerals 37 and 38 in FIG. 5, are respectively a signal path for supplying freezing control information.

The hit judgment control circuit 24 judges whether it is a cache hit or a cache miss, based on the freezing control information 37, the comparison result 35 of the tag address 33 and the tag data 34, and the valid data 36. At the time of cache miss, the hit judgment control circuit 24 outputs an access request 39 to the main memory (not shown) The hit judgment control circuit 24 also switches the output of the selector 27 to either the data RAM 23 side (see line 33) or the main memory side (see line 38). The hit judgment control circuit 24 further carries out update control of the stored data, with respect to the tag RAM 21, the valid RAM 22, and the data RAM 23.

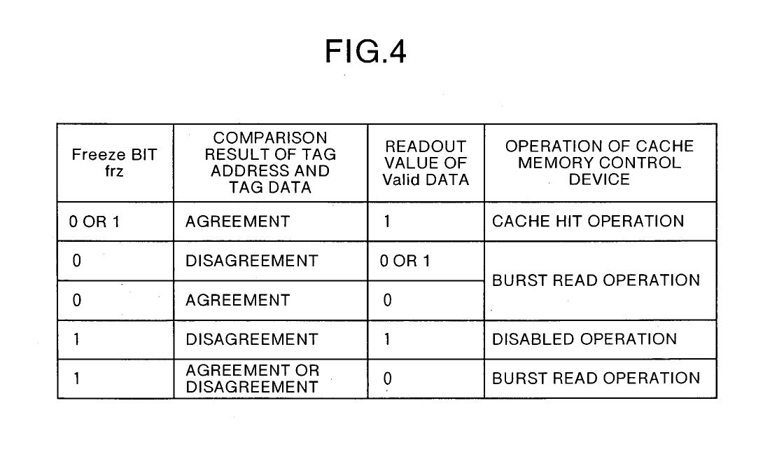

The operation at the time of cache hit and the operation at the time of cache miss will be explained, with reference to FIG. 4. If the comparison result 35 of the tag address 33 and the tag data 34 shows “agreement” and the valid data 36 is “1”, that is, indicating that the data is valid, it is judged to be a cache hit, regardless of the value of the freezing control information 37 supplied from the data RAM 23. In this case, the set address 32 is input to the data RAM 23, and the data corresponding to the input set address 32 is output from the data RAM 23 to the selector 27. The output of the selector 27 has been switched to the data RAM side, and hence the data output from the data RAM 23 is supplied to the CPU (not shown).

When the comparison result 35 of the tag address 33 and the tag data 34 shows “agreement”, and the valid data 36 is “0”, that is, indicating that the data stored in the data RAM 23 is invalid, it is a cache miss, and it is judged to perform the burst read operation, regardless of the value of the freezing control information 37. In this case, an access request 39 is output to the main memory (not shown) and the data corresponding to this access request 39 and the freezing control information accompanying the data are read from the main memory. A write request has been supplied to the data RAM 23 from the hit judgment control circuit 24, and hence the data and the freezing control information transmitted from the main memory are written at a position corresponding to the tag address on the data RAM 23. The data transmitted from the main memory is also supplied to the CPU.

At the time of the burst read operation, the tag address 33 has been supplied to the tag RAM 21, and a write request has been also supplied from the hit judgment control circuit 24, and hence the data is written at a position corresponding to the tag address on the tag RAM 21. At the time of the burst read operation, “1” has been supplied to the data input terminal DI of the valid RAM 22 from the hit judgment control circuit 24. Since a write request has been also supplied to the valid RAM 22 from the hit judgment control circuit 24, “1” is written at a position corresponding to the tag address on the valid RAM 22.

When the comparison result 35 of the tag address 33 and the tag data 34 shows “disagreement”, and the valid data 36 is “0”, it is also judged to perform the burst read operation, regardless of the value of the freezing control information 37 supplied from the data RAM 23. Further, when the comparison result 35 of the tag address 33 and the tag data 34 shows “disagreement”, and the valid data 36 is “1”, and the freezing control information 37 is “0”, it is also judged to perform the burst read operation. When the valid data 36 is “1”, it means that the data stored in the data RAM 23 is valid.

When the comparison result 35 of the tag address 33 and the tag data 34 shows “disagreement”, and the valid data 36 and the freezing control information 37 supplied from the data RAM 23 are both “1”, it is judged to perform a disabled operation. In this case, the hit judgment control circuit 24 outputs an access request 39 to the main memory (not shown). Since the operation as the cache is not carried out, the data returned from the main memory in response to the access request 39 is not stored in the data RAM 23, but transmitted to the CPU (not shown), through the selector 27, which has been switched to the main memory side.

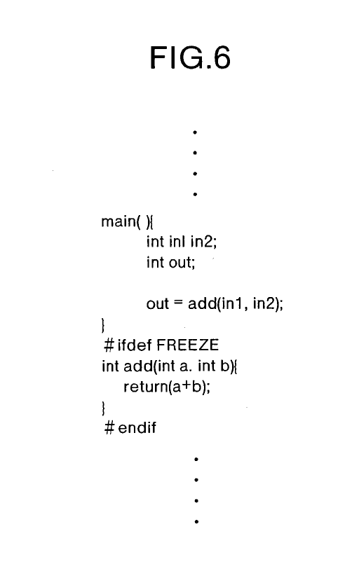

The freezing control information is added to the expanded data, when the CPU (not shown) expands the data to the main memory (not shown), in order to execute the application program stored in a ROM or an external memory (not shown). This program is described in, for example, a C language, being a high-level language. FIG. 6 shows a description example of the C program when the range to be frozen is instructed. As shown in FIG. 6, in this embodiment, a designator, “#ifdef FREEZE”, for specifying the start of the range, to which “1” is added as the freezing control information and a designator, “#endif”, for specifying the end of the range, to which “1” is added as the freezing control information are newly provided. By using a compiler or the like having a function of recognizing these designators, “1” is added as the freezing control information to the data in the specified range, at the time of data conversion.

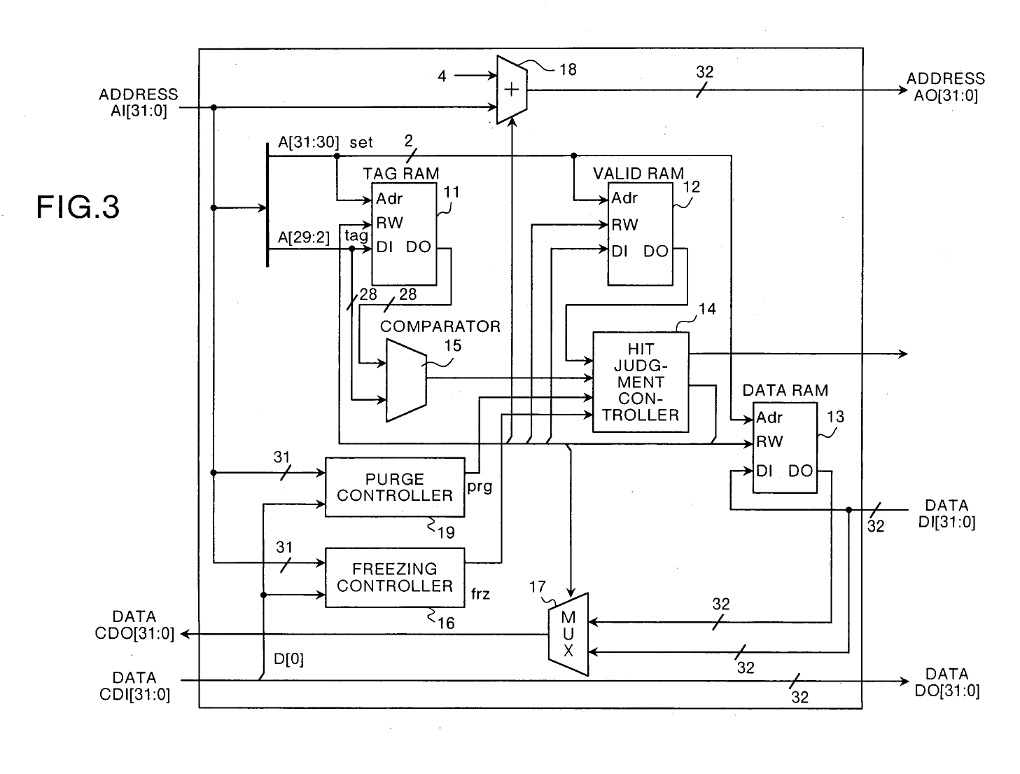

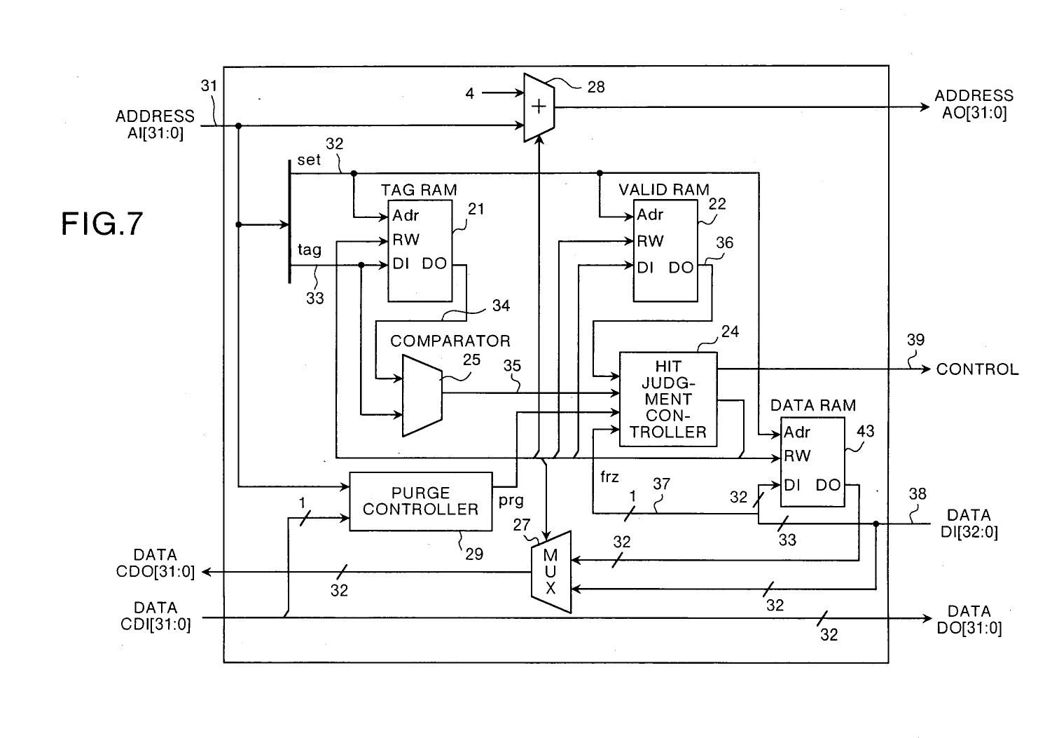

In the cache memory control device shown in FIG. 5, since the freezing control information is stored in the data RAM 23, the size of the data RAM 23 becomes larger than that of the conventional cache memory control device. Therefore, as in the cache memory control device shown in FIG. 7, the configuration may be such that the freezing control information is not stored in the data RAM 43. In the configuration shown in FIG. 7, the freezing control information is read from the main memory. The read freezing control information is supplied to the hit judgment control circuit 24, where it is judged whether the burst read operation is to be performed or the disabled operation is to be performed. According to the configuration shown in FIG. 7, since the size of the data RAM 43 is the same as that of the conventional cache memory control device, there is an advantage in that the circuit size becomes smaller than that of the conventional cache memory control device (see FIG. 3), because the freezing controller 16 is unnecessary.

According to this embodiment, the freezing control information is taken into the cache memory control device from the main memory, together with the data requested from the CPU, and setting of data which is made to reside in the cache is automatically performed, based on the freezing control information. Therefore, even if the freezing setting program is not provided separately as in the conventional cache memory control device, desired data can be made to reside in the cache automatically and reliably, only by executing the application program.

According to this embodiment, since command description for specifying the portion to be frozen in the application program is unnecessary, the application program can be described, without depending on the hardware configuration of the CPU, the cache memory control device or the like. Therefore, there is the effect that the portability of the application program is increased.

According to this embodiment, the application program can be prepared without considering the freezing control timing of data which is made to reside in the cache. Therefore, there is the effect that the burden on the programmer is decreased.

According to this embodiment, when the designation of the resident program is scattered, not only the freezing control information is added in the compiler, but also the freezing control information can be used as the information for making the data that is made to reside in the cache to reside efficiently in the data RAM 23 or 43 in the cache memory control device. For example, even when the data that is made to reside in the cache is arranged, in the normal situation, being overlapped on the data RAM 23, 43 in the cache memory control device, overlapped arrangement of the data that is made to reside in the cache can be avoided by correcting the arrangement based on the freezing control information.

The present invention is not limited to the above-described embodiment and can be variously changed. For example, the number of bits of the bus width and the number of bits of the freezing control information are optional. The present invention is not limited to the data cache, and is also applicable to an instruction cache which handles only instructions as an object to be controlled, or a unified cache which handles both instructions and data other than the instructions. The present invention is not limited to the direct map method, and is also applicable to other control methods such as the set associative method. When there is an unused bit in each instruction of the instruction cache and the CPU, the unused bit may be used for the freezing control information. In this case, the bit width of the data input from the main memory, and the size of the main memory may be the same as those in the conventional art.

Although the invention has been described with respect to a specific embodiment for a complete and clear disclosure, the appended claims are not to be thus limited but are to be construed as embodying all modifications and alternative constructions that may occur to one skilled in the art which fairly fall within the basic teaching herein set forth.

What is claimed is:

1. A cache memory control device comprising:
a data memory which stores data transmitted from an external main memory in response to a request from an external CPU, and freezing control information transmitted from the main memory together with the data, for inhibiting that the data is overwritten by other data;
a tag memory which stores an address corresponding to the data transmitted from the main memory in response to the request from the CPU;
a valid memory which stores a result of comparison of the address corresponding to the data transmitted from the main memory in response to the request from the CPU and the address stored in the tag memory;
a comparator which, when data is requested from the CPU, compares the address corresponding to the requested data and the address stored in the tag memory; and
a hit judgment controller which, when data is requested from the CPU, performs judgment whether it is a cache hit or a cache miss, based on the result of comparison by the comparator, the data stored in the valid memory, and the freezing control information stored in the data memory, which correspond to the requested data, and controls the overwrite inhibit of the data stored in the data memory.

2. The cache memory control device according to claim 1, wherein when overwrite of the data stored in the data memory is permitted, and when the result of comparison by the comparator shows disagreement, or the data stored in the valid memory indicates that the data stored in the data memory is invalid, the hit judgment controller transmits the data received from the main memory to the CPU by a burst read operation, and overwrites the data stored in the data memory and the freezing control information by the data received from the main memory and the freezing control information accompanying this data.

3. The cache memory control device according to claim 1, wherein when overwrite of the data stored in the data memory is inhibited, and when the result of comparison by the comparator shows disagreement, and the data stored in the valid memory indicates that the data stored in the data memory is valid, the hit judgment controller transmits the data received from the main memory to the CPU by a disabled operation, and holds the data stored in the data memory and the freezing control information.

4. The cache memory control device according to claim 1, wherein when overwrite of the data stored in the data memory is inhibited, and when the data stored in the valid memory indicates that the data stored in the data memory is invalid, the hit judgment controller transmits the data received from the main memory to the CPU by a burst read operation, and makes the data memory store the data received from the main memory and the freezing control information accompanying the data.

5. A cache memory control device comprising:
a data memory which stores data transmitted from an external main memory in response to a request from an external CPU;
a tag memory which stores an address corresponding to the data transmitted from the main memory in response to the request from the CPU;
a valid memory which stores a result of comparison of the address corresponding to the data transmitted from the main memory in response to the request from the CPU and the address stored in the tag memory;
a comparator which, when data is requested from the CPU, compares the address corresponding to the requested data and the address stored in the tag memory; and
a hit judgment controller which, when data is requested from the CPU, performs judgment whether it is a cache hit or a cache miss, based on the result of comparison by the comparator, the data stored in the valid memory, and freezing control information, which inhibits that the data transmitted from the main memory and stored in the data memory is overwritten by other data, and controls the overwrite inhibit of the data stored in the data memory.

6. The cache memory control device according to claim 5, wherein when overwrite of the data stored in the data memory is permitted, and when the result of comparison by the comparator shows disagreement, or the data stored in the valid memory indicates that the data stored in the data memory is invalid, the hit judgment controller transmits the data received from the main memory to the CPU by a burst read operation, and overwrites the data stored in the data memory by the data received from the main memory.

7. The cache memory control device according to claim 5, wherein when overwrite of the data stored in the data memory is inhibited, and when the result of comparison by the comparator shows disagreement, and the data stored in the valid memory indicates that the data stored in the data memory is valid, the hit judgment controller transmits the data received from the main memory to the CPU by a disabled operation, and holds the data stored in the data memory.

8. The cache memory control device according to claim 5, wherein when overwrite of the data stored in the data memory is inhibited, and when the data stored in the valid memory indicates that the data stored in the data memory is invalid, the hit judgment controller transmits the data received from the main memory to the CPU by a burst read operation, and makes the data memory store the data received from the main memory and the freezing control information accompanying the data.

9. A cache memory system comprising:
a cache memory control device; a CPU connected to the cache memory control device; a main memory connected to the cache memory control device; wherein the cache memory control device including
a data memory which stores data transmitted from the main memory in response to a request from the CPU, and freezing control information transmitted from the main memory together with the data, for inhibiting that the data is overwritten by other data;
a tag memory which stores an address corresponding to the data transmitted from the main memory in response to the request from the CPU;
a valid memory which stores a result of comparison of the address corresponding to the data transmitted from the main memory in response to the request from the CPU and the address stored in the tag memory;
a comparator which, when data is requested from the CPU, compares the address corresponding to the requested data and the address stored in the tag memory; and
a hit judgment controller which, when data is requested from the CPU, performs judgment whether it is a cache hit or a cache miss, based on the result of comparison by the comparator, the data stored in the valid memory, and the freezing control information stored in the data memory, which correspond to the requested data, and controls the overwrite inhibit of the data stored in the data memory;
a program memory which stores a program in which when data is expanded to the main memory by the CPU, description for adding freezing control information to the data in a specified range is possible; and
a signal path for supplying freezing control information to the hit judgment controller in the cache memory control device from the main memory.

10. A cache memory system comprising:
a cache memory control device; a CPU connected to the cache memory control device; a main memory connected to the cache memory control device; wherein the cache memory control device including
a data memory which stores data transmitted from the main memory in response to a request from the CPU;
a tag memory which stores an address corresponding to the data transmitted from the main memory in response to the request from the CPU;
a valid memory which stores a result of comparison of the address corresponding to the data transmitted from the main memory in response to the request from the CPU and the address stored in the tag memory;
a comparator which, when data is requested from the CPU, compares the address corresponding to the requested data and the address stored in the tag memory; and
a hit judgment controller which, when data is requested from the CPU, performs judgment whether it is a cache hit or a cache miss, based on the result of comparison by the comparator, the data stored in the valid memory, and freezing control information, which inhibits that the data transmitted from the main memory and stored in the data memory is overwritten by other data, and controls the overwrite inhibit of the data stored in the data memory;
a program memory which stores a program in which when data is expanded to the main memory by the CPU, description for adding freezing control information to the data in a specified range is possible; and
a signal path for supplying freezing control information to the hit judgment controller in the cache memory control device from the main memory.
